(19) United States
(12) Patent Application Publication
(10) Pub. No.: US 2006/0175968 A1
(43) Pub. Date: Aug. 10, 2006

(54) ENERGY CONVERTER

(76) Inventors: Mitsuhiko KIMOTO, Nara (JP); Kazuaki Ohkubo, Osaka (JP); Makoto Horiuchi, Nara (JP); Yuriko Kaneko, Nara (JP); Mika Sakaue, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/278,165

(22) Filed: Mar. 31, 2006

Related U.S. Application Data
(63) Continuation of application No. PCT/JP05/14396, filed on Aug. 5, 2005.

(30) Foreign Application Priority Data
Oct. 14, 2004 (JP) 2004-299852

(51) Int. Cl. H01K 1/02

(52) U.S. Cl. 313/578

(57) ABSTRACT

An incandescent lamp according to the present invention includes a radiator (such as a filament 102), which includes a plurality of cavities 120 that are arranged on at least some area of its surface in order to suppress radiations having wavelengths that are longer than a predetermined value, and a glass bulb 101 for shutting off the filament 102 from the air. The area of the filament 102 includes a layer including tungsten and carbon (such as a tungsten carbide layer), and a gas including carbon and an inert gas are enclosed within the glass bulb 101.

This is a continuation of International Application PCT/JP2005/014396, with an international filing date of Aug. 5, 2005, which claims priority of Japanese Patent Application No. 2004-299852, filed on Oct. 14, 2004, the contents of which are hereby incorporated by reference.

### BACKGROUND OF THE INVENTION

1. Field of the Invention

The present invention relates to an energy converter including a radiator that produces radiations, having wavelengths longer than a predetermined value, at a decreased rate, and more particularly relates to an incandescent lamp including a filament for converting electrical energy into light.

2. Description of the Related Art

An incandescent lamp, used extensively today as a common illumination source, includes a filament functioning as a thermal radiator. The “thermal radiator” is a radiation source that emits an electromagnetic wave by thermal radiation. And the “thermal radiation” means radiation (of an electromagnetic wave) produced by applying heat energy to atoms or molecules of an object. The thermal radiation energy is determined by the temperature of the object and has a continuous spectrum. In the following description, the thermal radiator will be simply referred to herein as a “radiator” or a “filament”.

An incandescent lamp achieves an excellent color rendering index and can be lit by a simple unit. However, as the incandescent lamp uses a radiation produced by a filament that is generating heat, the radiation produced by the incandescent lamp in the visible wavelength range is just 10% of the overall radiations thereof (in a situation where the operating temperature is 2,600 K, for example). More specifically, the majority of the other radiations are infrared radiations, of which the energy density accounts for as much as about 70% of that of the overall radiations. Also, the current incandescent lamp causes heat conduction due to an enclosed gas or a heat loss of as much as about 20% due to convection and has a visible radiation efficiency of only about 15 lm/W. Thus, various techniques of improving the visible radiation efficiency by cutting down the infrared radiations, which account for about 70% of the overall electromagnetic waves emitted from the radiator, have been researched.

It was reported that to improve the efficiency of a lamp by suppressing such infrared radiations, it was effective to create very small unevenness on the surface of a filament (Japanese Patent Application Laid-Open Publication No. 03-102701 (page 6, lower left column), for example). FIGS. 6A and 6B illustrate a device as disclosed in Japanese Patent Application Laid-Open Publication No. 03-102701. In the device shown in FIGS. 6A and 6B, cavity waveguides, having a square cross section with a length of 0.35 μm each side and a depth of 7 μm, are arranged on the surface of tungsten. By adopting such a configuration, radiations having wavelengths that are longer than a predetermined value (e.g., a wavelength of 700 nm or more) can be cut down and the lamp efficiency can be increased. More specifically, the configuration shown in FIGS. 6A and 6B is expected to increase the lamp efficiency six-fold at an operating temperature of 2,000 K to 2,100 K compared to conventional ones.

The spectrum of thermal radiation in thermal equilibrium state depends on the temperature following the Planck radiation formula. FIG. 2 is a graph showing the temperature dependence of blackbody radiation. In FIG. 2, the ordinate represents the spectral radiance B_{λ}Δλ [W·cm⁻² str⁻¹] (where Δλ=10 nm) of blackbody, while the abscissa represents the wavelength [μm] of radiation. If the operating temperature of an incandescent lamp is 1,600 K, for example, then the spectral radiance distribution of the light radiated from its filament is represented by a curve with “1600 K” in this graph. This curve shows that the peak is located at a wavelength of about 2 μm and that infrared radiations account for a high percentage.

As is clear from FIG. 2, if the temperature of the radiator increases from 1,200 K to 2,000 K, then the radiation in the visible range increases by three orders of magnitude or more but the radiation in the infrared range does not change so much. That is why to produce visible radiation efficiently, the operating temperature is preferably set to at least 2,000 K. Particularly when the radiator is used as an illumination source, the operating temperature should not be lower than 2,000 K because the resultant light would be excessively reddish if the operating temperature fell short of 2,000 K. For that reason, the radiator is preferably made of a refractory material such as tungsten that can withstand a high-temperature operation at 2,000 K or more.

The present inventors actually made such an array of very small uneven structures (which will be referred to herein as “cavities”) on the surface of a tungsten radiator and carried out various experiments on that radiator. As a result, in a tungsten radiator with an array of microcavities, each having a size of 1 μm or less, that array of cavities collapsed in a short time at a temperature of about 1,200 K, which is a sort of unusual and curious phenomenon because tungsten has a melting point of 3,650 K.

As described above, the filament of an incandescent lamp needs to operate at as high a temperature as 2,000 K or more and the incandescent lamp should have a sufficiently long life. If that specially designed cavity array structure, which has been reduced to a sub-micron dimension in order to minimize the infrared radiations, collapsed so easily, then such a radiator would no longer be applicable to an incandescent lamp and other devices that need to operate at elevated temperatures.

In order to overcome the problems described above, a primary object of the present invention is to provide an incandescent lamp that can operate for a sufficiently long time with good stability even at an elevated temperature by extending the life of a radiator having a microcavity structure with an inside diameter of 5 μm or less.

### SUMMARY OF THE INVENTION

An incandescent lamp according to the present invention includes an enclosure and a filament, which is arranged inside the enclosure and which includes a plurality of cavities that are arranged on at least some area of its surface. The area of the filament includes a layer including tungsten and carbon and a gas including carbon-containing molecules is enclosed within the enclosure.

In one preferred embodiment, the gas including carbon-containing molecules includes a hydrocarbon.

In this particular preferred embodiment, the hydrocarbon is represented by the general formula CₙHₘ (where n and m are integers).

In a specific preferred embodiment, m=2n+2 is satisfied.

More specifically, n is an integer of one through three.

In another preferred embodiment, the layer including tungsten and carbon is a layer including tungsten carbide.

In still another preferred embodiment, the cavities have the function of suppressing radiations having wavelengths that are longer than a predetermined value.

In yet another preferred embodiment, the cavities have a cylindrical shape with a diameter of 5 μm or less.

An energy converter according to the present invention includes an enclosure and a radiator, which is arranged inside the enclosure and which includes a plurality of cavities that are arranged on at least some area of its surface. The area of the radiator includes a layer including tungsten and carbon, and a gas including carbon-containing molecules is enclosed within the enclosure.

A power generator according to the present invention includes the energy converter of the present invention and an element for converting radiations, produced by the energy converter, into electrical energy.

According to the present invention, a gas including carbon can minimize the evaporation of a layer including carbon and tungsten and can prevent the cavity structures from collapsing or disappearing. As a result, a long-life incandescent lamp that converts thermal energy into visible radiation efficiently and radiates the light is realized.

### BRIEF DESCRIPTION OF THE DRAWINGS

FIG. 1 is a front view of an incandescent lamp according to a first preferred embodiment of the present invention.

FIG. 2 is a graph showing the spectral radiances of blackbody radiation.

Portion (a) of FIG. 3 is a plan view illustrating the surface of a radiator for use in a preferred embodiment of the present invention, portion (b) of FIG. 3 is a partial enlarged view thereof, and portion (c) of FIG. 3 is a cross-sectional view thereof as viewed on the plane I-I′ shown in portion (b) of FIG. 3.

Portions (a) and (b) of FIG. 4 are surface SEM photographs of a radiator as a comparative example that has not yet been heated and the same radiator that has been heated, respectively.

Portions (c) and (d) of FIG. 4 are surface SEM photographs of a radiator 301 as a preferred embodiment of the present invention that has not yet been heated and the same radiator that has been heated, respectively.

FIG. 5 is a graph showing the emissivity values of tungsten (W) and tungsten carbide (WC), which were measured in the infrared range.

FIGS. 6A and 6B are respectively a top view and a cross-sectional view of a device that includes a radiator on which an array of cavities has been formed.

FIGS. 7A, 7B and 7C are SEM photographs of a filament that had not been heated yet, a filament that was heated in a vacuum, and a filament that was heated in an atmosphere to which 1 vol % of CH₄ gas was added, respectively. The photos on the top row show overall cross sections of the samples, the photos on the intermediate row show cross sections of the samples near their surface on a larger scale, and the photos on the bottom row are surface SEM photographs of the samples.

FIG. 8 is a perspective view illustrating a thermoelectric converter according to a second preferred embodiment of the present invention.

### DETAILED DESCRIPTION OF PREFERRED EMBODIMENTS

The present inventors discovered and confirmed via experiments that when a layer including carbon and tungsten (which is a tungsten compound layer typically made of tungsten carbide) was formed on the surface of a radiator, the array of cavities exhibited increased thermal stability and the microstructure on the surface did not collapse but maintained its original shape even at an elevated temperature (in U.S. Patent Application Publication No. US2005/0263269). Thus, the present inventors hoped to realize an incandescent lamp with a long life by using such a radiator as the filament of the incandescent lamp.

However, as a result of further experiments, the present inventors also discovered that the life of an incandescent lamp could not be extended as expected because tungsten carbide evaporated at a higher rate than tungsten.

Nevertheless, the present inventors also discovered that the decrease in the weight of the layer including tungsten and carbon on the surface of the radiator could be minimized by adding a gas including carbon to an inert gas, thus getting the basic idea of the present invention.

An incandescent lamp according to the present invention includes a filament (i.e., an exemplary radiator), which includes a plurality of cavities (microcavities) that are arranged on at least some area of its surface and an enclosure for shutting off the filament from the air. The area of the filament includes a layer including tungsten and carbon and a gas including carbon-containing molecules is enclosed within the enclosure. The layer including tungsten and carbon is typically made of tungsten carbide (WC).

In this incandescent lamp, when electrical or thermal energy is supplied to the filament, the radiator converts that energy into radiation energy. According to a preferred embodiment of the present invention, a huge number of microcavities that are present on the surface of the radiator suppress radiations, of which the wavelengths are longer than a predetermined wavelength that is defined by the size of the microcavities. That is why compared to a lamp with no cavities, the radiation spectrum intensifies in the range that is equal to or lower than the predetermined wavelength.

An apparatus including such a radiator may be used not just as an illumination source for converting electricity into light but also as an energy converter for converting the spectrum of solar energy into that of a solar cell with high conversion efficiency.

In the present invention, the gas (i.e., the ambient gas) enclosed in the enclosure of the filament plays a key role. However, first, it will be described how the tungsten carbide layer on the surface of the filament prevents the microcavities from collapsing. After that, it will be described what effects will be caused by adding a gas including carbon to the ambient gas. <Life Test on Tungsten Compound Layer>

Portion (a) of FIG. 3 is a plan view schematically illustrating the surface of a radiator 301 for use in a preferred embodiment of an incandescent lamp according to the present invention. In portion (b) of FIG. 3, the dashed rectangle schematically illustrates a part of the surface of the radiator 301 on a larger scale. And portion (c) of FIG. 3 is a cross-sectional view thereof as viewed on the plane I-I′ shown in portion (b) of FIG. 3.

The radiator 301 has a ribbon shape as a whole with a width of 0.1 mm, a length of 10 mm and a thickness of 0.05 mm, and is made essentially of tungsten. On the surface of the radiator 301, formed is an array of cavities 310, each of which has a cylindrical shape with a diameter of 0.7 μm and a depth of 1.2 μm. These cavities 310 have a size of 5 μm or less (typically 1 μm or less) each on a plane that is defined parallel to the radiation plane, and will be referred to herein as “microcavities”.

In this preferred embodiment, these microcavities 310 are arranged substantially regularly on the surface of the radiator 301 and the arrangement pitch (i.e., the distance between the center axes of two adjacent cavities) is set to 1.4 μm.

Those microcavities 310 can be made by any of various fine-line patterning processes. In this preferred embodiment, the microcavities 310 are made by irradiating the surface of the radiator with a pulsed laser beam. Such a method of making very small recesses on the surface of a workpiece using a pulsed laser beam is described in Japanese Patent Application Laid-Open Publication No. 2001-314989, for example. More specifically, in this preferred embodiment, the fine-line patterning process is carried out by irradiating the radiator with a laser beam having a pulse energy of 0.1 mJ and a pulse width of 100 femtoseconds. The radiator 301 is repeatedly exposed to these laser pulses several tens to several thousands of times to make just one microcavity 310.

The radiator 301 to be patterned with the laser beam is put on an X-Y stage. By irradiating the radiator with the laser beam synchronously with the movement of the X-Y stage, an array of microcavities such as that shown in FIG. 3 can be made. And if the movement of the X-Y stage is controlled with high precision, then the arrangement pattern of the array can be defined arbitrarily. The inside diameter and depth of the microcavities 310 can be set to arbitrary values by adjusting the irradiation energy density, beam spot size, number of shots and other parameters of the laser pulses.

Optionally, to make a huge number of microcavities at the same time, the photolithography and etching techniques, which are used extensively in semiconductor device fabrication and microelectromechanical systems technologies, may also be adopted.

As shown in portion (c) of FIG. 3, a surface region of the radiator 301 to a depth of about 1.8 μm as measured from the radiation plane of the radiator 301 is a layer including tungsten and carbon, which is a tungsten compound layer including tungsten carbide [WC or W₂C] and which will be simply referred to herein as a “tungsten compound layer” or a “WC layer”.

In this preferred embodiment, the surface of tungsten is subjected to a carburizing process to make such a tungsten compound layer. The carburizing process is a process for carbonizing the surface of a metal, for example, and may be carried out by any of various methods that have been developed so far. For example, according to a plasma carburizing process, using the furnace body or insulator as an anode and the workpiece as a cathode, respectively, a high DC voltage is applied between these electrodes in a mixed gas atmosphere, including argon, hydrogen and a methane hydrocarbon such as methane or propane, thereby generating glow discharge and eventually plasma. In the plasma, various electrochemical reactions set in to make ions of methane or propane bombard on the surface of the workpiece and thereby produce carburizing. This plasma carburizing process is more effective in activating, cleaning or reducing the surface of the workpiece than any other type of carburizing process. In a preferred embodiment, the carburizing process is preferably carried out at a temperature of 700 K to 2,900 K (e.g., at 1,400 K) for 4 to 48 hours (e.g., for 8 hours). By modifying the carburizing process conditions, the thickness of the resultant tungsten compound layer can be controlled.

However, the tungsten compound layer does not have to be made by such a carburizing process but may also be formed by introducing a constituent element of the compound, such as carbon, into tungsten by either ion implantation or solid-phase diffusion. The layer formed by the carburizing process has a thickness of about 1.8 μm.

Hereinafter, it will be described how effectively the carburizing process can minimize the collapse of cavities 310 in the radiator 301.

A radiator 301, of which the surface had been subjected to the carburizing process, and a radiator representing a comparative example, of which the surface had not been subjected to the carburizing process, were prepared and heated at 2,000 K for 10 minutes in a vacuum with a pressure of about 10⁻⁴ Torr. The results are shown in FIG. 4. Specifically, portions (a) and (b) of FIG. 4 are surface SEM photographs of the radiator as a comparative example that had not been heated yet and the same radiator that had been heated, respectively. Portions (c) and (d) of FIG. 4 are surface SEM photographs of the radiator 301 as a preferred embodiment of the present invention that had not been heated yet and the same radiator that had been heated, respectively. The surface of the radiator 301 shown in portions (c) and (d) of FIG. 4 is the tungsten compound layer described above.

As can be seen from FIG. 4, the cavity structure of the radiator 301 of this preferred embodiment did not change at all even after having been subjected to the heating test, while the cavity structure of the radiator as the comparative example collapsed completely after the test with no traces left. Thus, it was confirmed that by forming a layer including carbon on the surface of a tungsten radiator, the thermal stability of the array of cavities could be increased and the microstructure on the surface did not collapse but was maintained as it was even when exposed to an elevated temperature.

In the example described above, a tungsten compound layer with a thickness of about 2 μm was used. However, a tungsten compound layer with a thickness of approximately several tens of nm or more should increase the thermal stability of the cavities sufficiently. <Life Experiment on Tungsten Compound Layer>

The present inventors carried out an experiment to predict the life of a tungsten compound layer made of tungsten carbide. The results will be described below. In this test, a sample of tungsten carbide (WC bulk) and a sample of tungsten (W bulk) were heated in a low-pressure Ar gas and in an atmospheric-pressure Ar gas, and the variation in the weight of each of these samples before and after the sample had been heated was calculated, thereby determining whether the material of the sample evaporated or not.

In this experiment, no cavities 310 such as those illustrated in portions (b) and (c) of FIG. 3 were formed on the surface of either sample to determine whether the sample evaporated or not, but disklike samples were used. Each sample had a diameter of 20 mm and a thickness of 4 mm and was heated at 2,023 K (=1,750° C.) for 100 hours. The results are shown in the following Tables 1 and 2:

TABLE 1
Under low pressure

| | | |
|---|---|---|
| Before | After | Variation in average |

| | | heating | heating | [g] | ppm |
|---|---|---|---|---|---|
| WC | \textcircled{1} | 20.240 | 20.236 | | |
| Bulk | \textcircled{2} | 20.239 | 20.236 | | |
| | \textcircled{3} | 20.240 | 20.236 | | |
| | \textcircled{4} | 20.240 | 20.236 | | |
| | \textcircled{5} | 20.240 | 20.236 | | |
| | Average | 20.240 | 20.236 | −0.004 | −188 |
| W | \textcircled{1} | 30.720 | 30.717 | | |
| Bulk | \textcircled{2} | 30.720 | 30.717 | | |
| | \textcircled{3} | 30.720 | 30.717 | | |
| | \textcircled{4} | 30.719 | 30.717 | | |
| | \textcircled{5} | 30.719 | 30.717 | | |
| | Average | 30.720 | 30.717 | −0.003 | −85 |

Ambient gas: Ar
Pressure: 10⁻⁴ Pa
Heating conditions: 1,750° C., 100 hrs

TABLE 2
Under the atmospheric pressure

| | | |
|---|---|---|
| Before | After | Variation in average |

| | | heating | heating | [g] | ppm |
|---|---|---|---|---|---|
| WC | \textcircled{1} | 20.236 | 20.233 | | |
| Bulk | \textcircled{2} | 20.236 | 20.233 | | |
| | \textcircled{3} | 20.236 | 20.233 | | |
| | \textcircled{4} | 20.236 | 20.233 | | |
| | \textcircled{5} | 20.236 | 20.233 | | |
| | Average | 20.236 | 20.233 | −0.003 | −148 |
| W | \textcircled{1} | 30.717 | 30.717 | | |
| Bulk | \textcircled{2} | 30.717 | 30.717 | | |
| | \textcircled{3} | 30.717 | 30.717 | | |
| | \textcircled{4} | 30.717 | 30.717 | | |
| | \textcircled{5} | 30.717 | 30.717 | | |
| | Average | 30.717 | 30.717 | 0.000 | 0 |

Ambient gas: Ar
Pressure: the atmospheric pressure
Heating conditions: 1,750° C., 100 hrs

Table 1 shows the weights [g] of W bulk and WC bulk, which were measured five times before the bulks were heated and five more times after they were heated, the averages of their weights, and the variations in averages before and after the bulks were heated in a situation where the furnace was filled with an Ar gas with a pressure of 10⁻⁴ Pa. Table 2 shows the results of similar measurements, which were carried out in a furnace that was filled with an Ar gas at the atmospheric pressure. Also, in Tables 1 and 2, the ratio of the variation in average to the average is also shown by weight ppm.

As can be seen from Table 1 and 2, the weight of the W bulk decreased slightly in the low-pressure Ar gas but did not change at all in the atmospheric-pressure Ar gas. On the other hand, the weight of the WC bulk decreased irrespective of the pressure of the ambient gas. The decrease in the weight would have been caused by the evaporation of at least a part of the surface layer of the sample. That is to say, the surface substance of the WC bulk evaporates when heated in the Ar gas atmosphere. That is why if a WC layer is formed on the surface of a filament, the evaporation of the WC layer might collapse the cavity structure.

<Means for Minimizing Evaporation of Tungsten Carbide Layer>

In this experiment, WC bulk and W bulk with no cavities were used as samples as in the experiment described above. Each sample had a diameter of 20 mm and a thickness of 4 mm as in the experiment described above. These samples were heated in an inert gas to which a gas including carbon had been added, and their variations in weight before and after they were heated were calculated. Each sample was heated at 2,023 K for 50 hours.

The ambient gas consisted essentially of 99 vol % of Ar gas and 1 vol % of methane (CH₄) gas and the overall pressure thereof was set equal to the atmospheric pressure.

Table 3 shows the weights [g] of the W bulk and the WC bulk, which were measured five times before the bulks were heated and five more times after they were heated, the averages of their weights, and the variations in averages before and after the bulks were heated. Also, in Table 3, the ratio of the variation in average before and after the heating to the average is also shown by weight ppm.

TABLE 3
When CH₄ was added to ambient gas

| | | |
|---|---|---|
| Before | After | Variation in average |

| | | heating | heating | [g] | ppm |
|---|---|---|---|---|---|
| WC | \textcircled{1} | 27.146 | 27.149 | | |
| Bulk | \textcircled{2} | 27.147 | 27.149 | | |
| | \textcircled{3} | 27.147 | 27.149 | | |
| | \textcircled{4} | 27.147 | 27.149 | | |
| | \textcircled{5} | 27.147 | 27.149 | | |
| | Average | 27.147 | 27.149 | 0.002 | 81 |
| W | \textcircled{1} | 32.822 | 32.901 | | |
| Bulk | \textcircled{2} | 32.822 | 32.901 | | |
| | \textcircled{3} | 32.822 | 32.902 | | |
| | \textcircled{4} | 32.822 | 32.902 | | |
| | \textcircled{5} | 32.822 | 32.902 | | |
| | Average | 32.822 | 32.902 | 0.080 | 2425 |

Ambient gas: 1% of CH₄ + 99% of Ar
Pressure: the atmospheric pressure
Heating conditions: 1,750° C., 50 hrs

As can be seen from Table 3, not only the weight of the W bulk but also that of the WC bulk increased as a result of the heating. The weight could have been increased as a result of carburization that would have been produced on the surface of each sample due to the action of carbon included in the ambient gas.

The results of this experiment reveal that just by adding a methane hydrocarbon gas such as CH₄ slightly to the ambient gas, the evaporation of the WC bulk that had been heated to an elevated temperature could be minimized. This effect was also achieved even when a tungsten carbide layer was formed on the surface of the cavities. That is to say, by adding a gas including carbon (such as a methane hydrocarbon) to the atmosphere surrounding the radiator, the evaporation of WC or C from the surface of the radiator can be minimized and the collapse of the cavities can be prevented for a long time.

In this preferred embodiment, methane is used as a gas including carbon. However, similar effects will also be achievable even when a methane hydrocarbon such as propane represented by the general formula CₙH₂n+₂ (where n is an integer) or a hydrocarbon represented by the general formula CₙHₘ (where n and m are integers) is used.

<Cavity Array Structure>

The present inventors also carried out an experiment on samples in which an array of cavities was formed on the surface. The results of the experiment will be described with reference to FIGS. 7A through 7C.

FIGS. 7A, 7B and 7C are SEM photographs of a filament that had not been heated yet, a filament that was heated in a vacuum, and a filament that was heated in an atmosphere to which 1 vol % of CH₄ gas was added, respectively. The photos on the top row show overall cross sections of the samples, the photos on the intermediate row show cross sections of the samples near their surface on a larger scale, and the photos on the bottom row are surface SEM photographs of the samples. The samples shown on the top and intermediate rows are coated with a resin.

On the surface of a filament that had not been heated yet, formed was a tungsten carbide layer to a thickness of about 3 μm by a carburizing process. Each cavity was a cylindrical hole with a diameter of 0.7 μm and a depth of 0.7 μm. The arrangement pitch (i.e., the distance between the respective centers of two adjacent cavities) was 1.4 μm.

The heating process was conducted at 2,023 K for 24 hours in both cases. As shown in FIG. 7B, when the heating process in the low-pressure atmosphere (at a pressure of 10⁻⁴ Pa) was finished, the tungsten carbide layer had already evaporated away and the array of cavities had disappeared, too. The region where there was the tungsten carbide layer turned into a gap that had been created between the resin layer and tungsten.

On the other hand, when the heating process in the atmosphere, to which the CH₄ gas had been added, was finished, the tungsten carbide layer had never evaporated but rather increased its thickness and the array of cavities never disappeared, either, as shown in FIG. 7C. The tungsten carbide layer thickened due to the carbonization of tungsten (which is a phenomenon similar to the carburizing process) that would have been caused by the supply of carbon from the ambient gas onto the surface of the filament.

As can be seen from the results of this experiment, by adding a gas including carbon to the ambient gas, the array of cavities never disappeared but the surface microstructure was maintained as it was for a long time even at a high temperature exceeding about 2,000 K.

<Embodiment of Light Bulb According to the Present Invention>

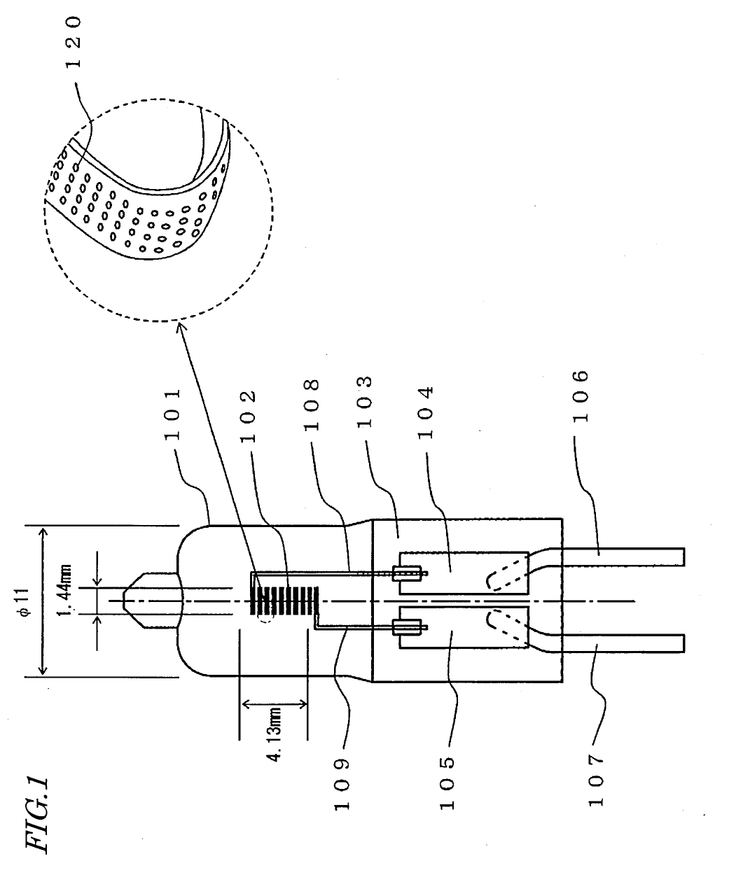

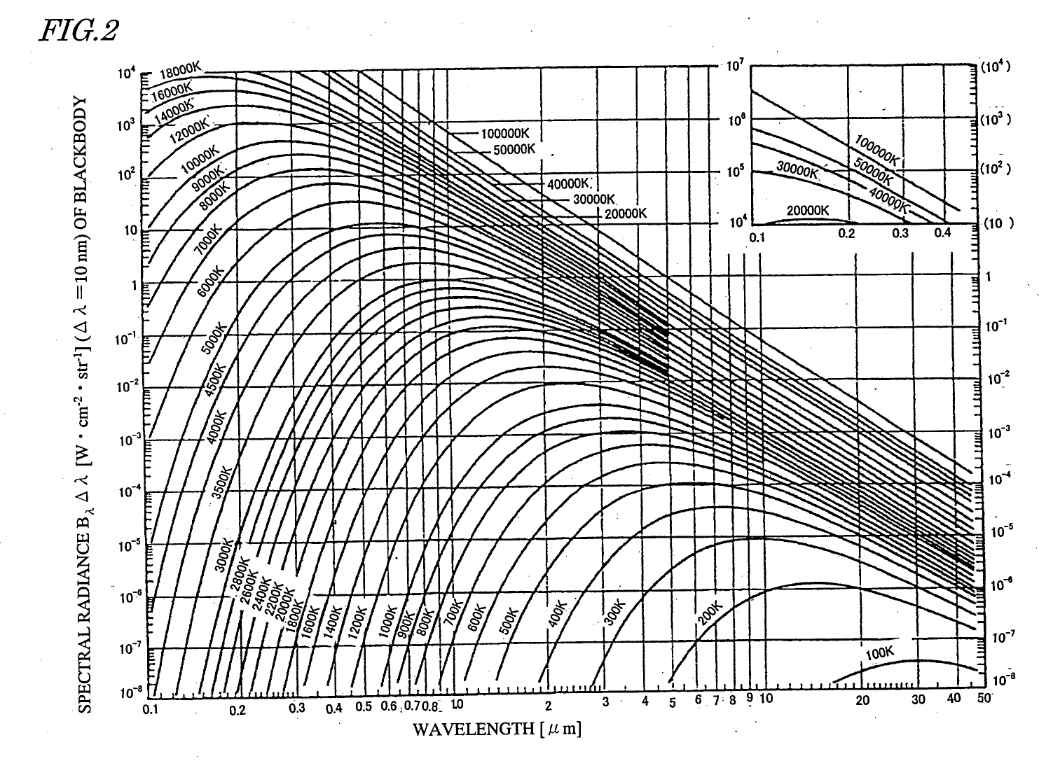

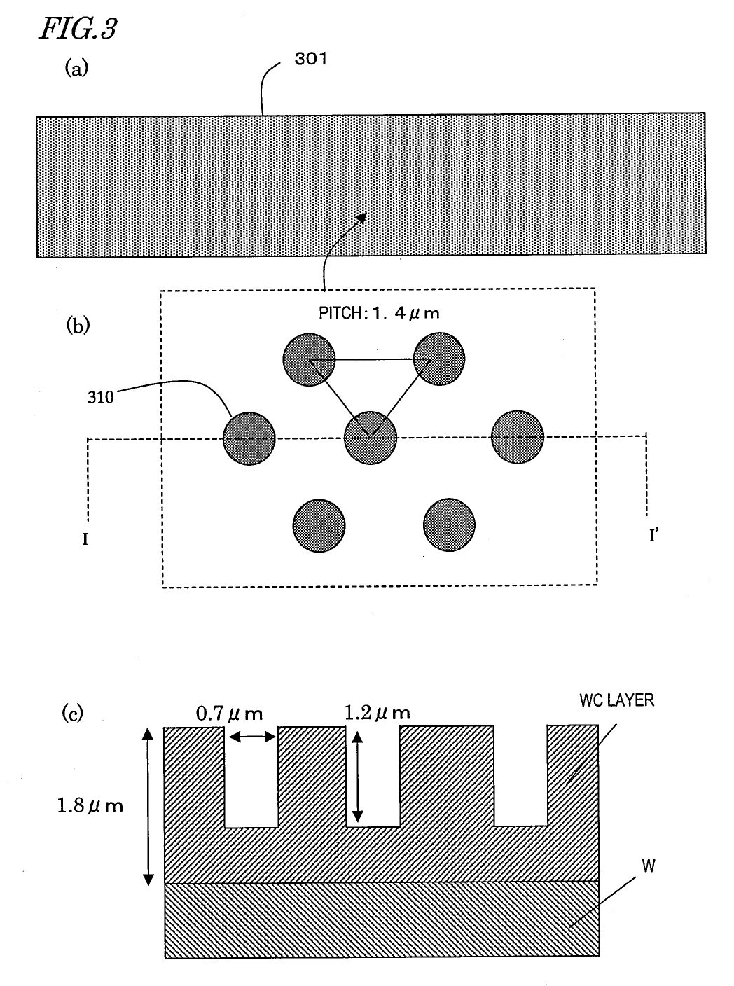

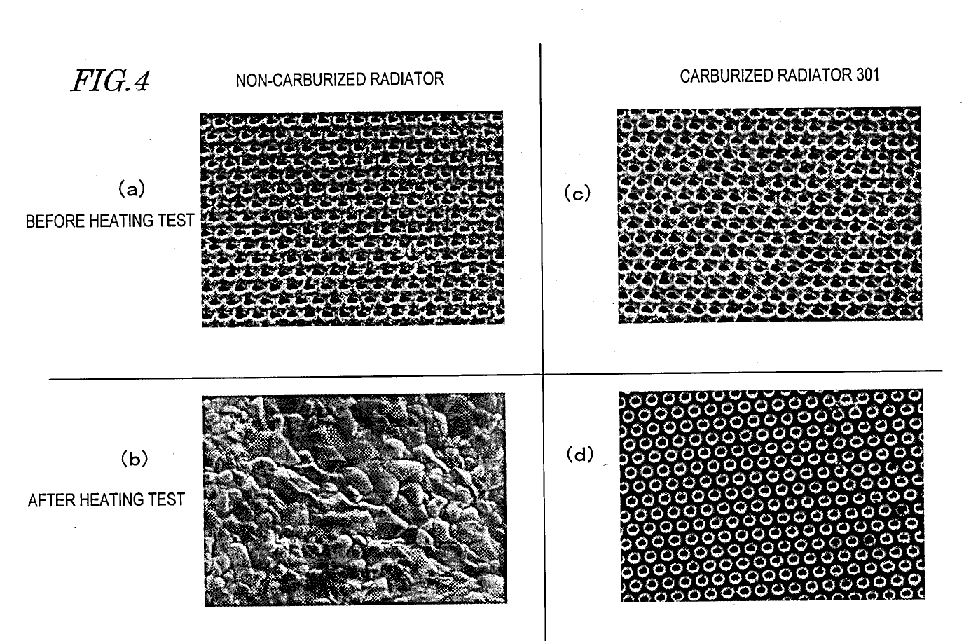

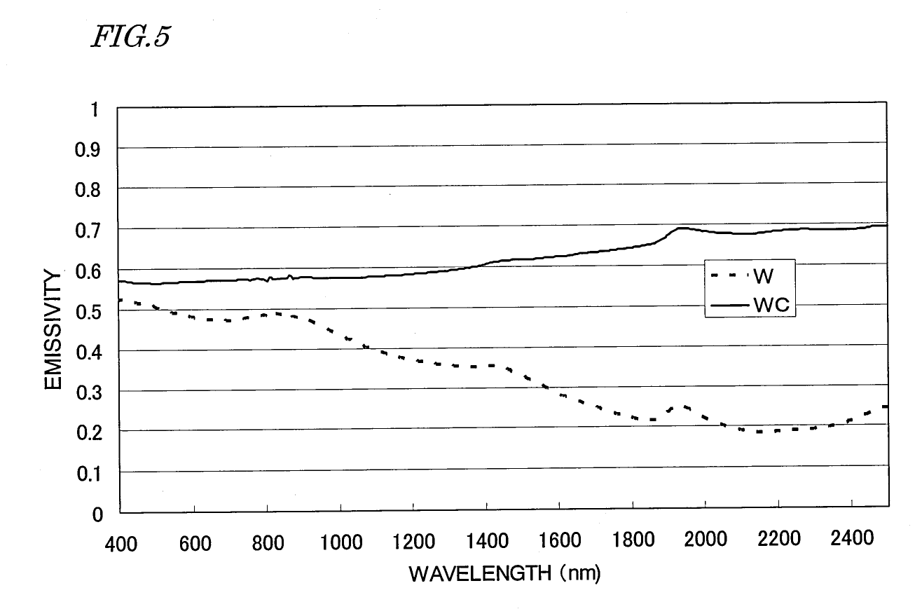

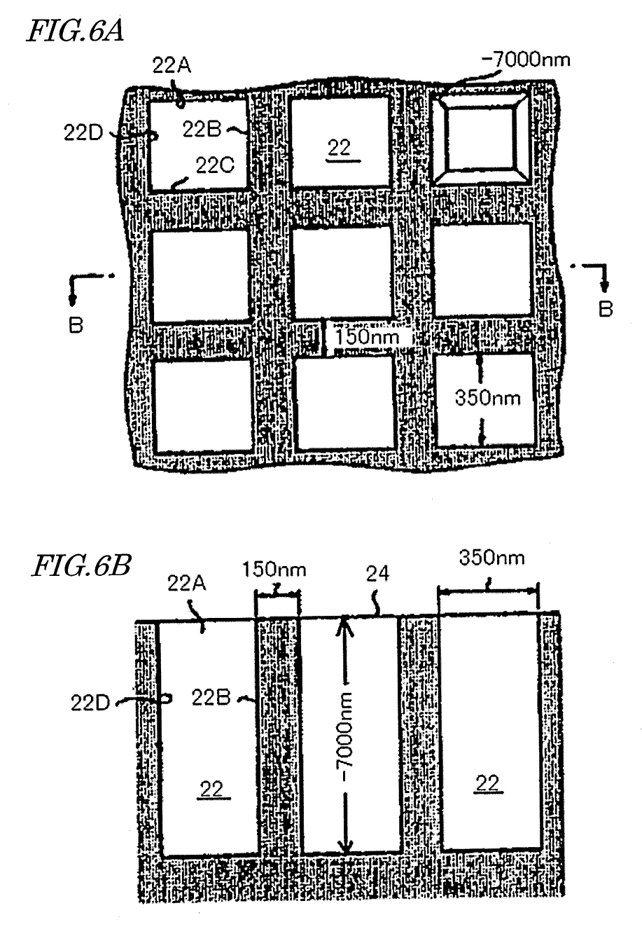

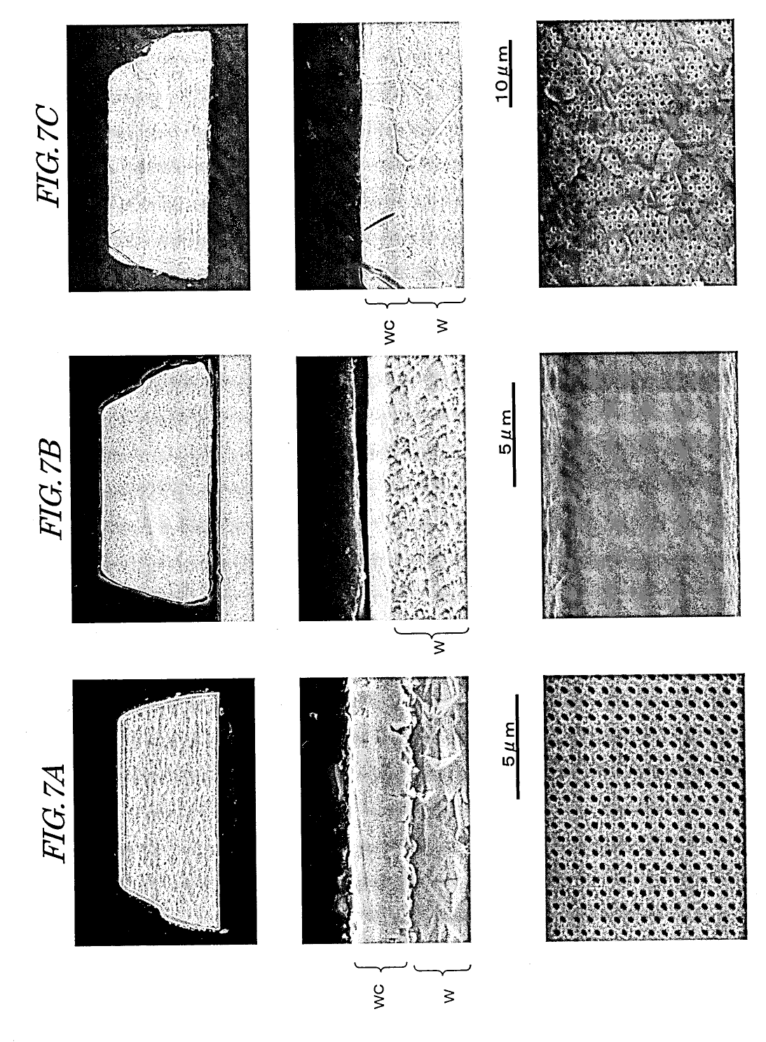

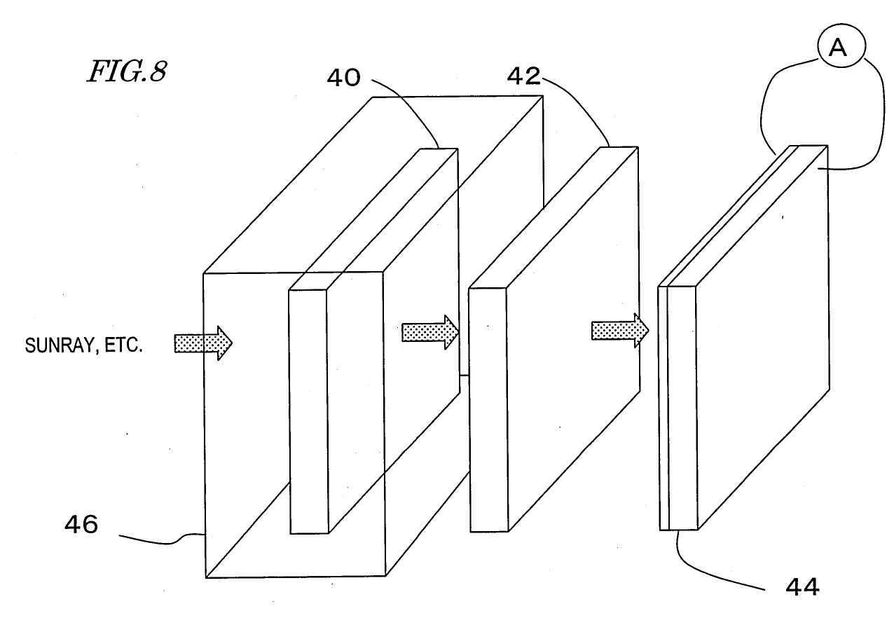

Hereinafter, an embodiment of an incandescent lamp (light bulb) according to the present invention will be described with reference to FIG. 1, which illustrates an exemplary configuration for this preferred embodiment.

This incandescent lamp includes a filament (radiator) 102 that emits radiated light, a translucent glass bulb 101 for shutting off the filament 102 from the air, stems 108 and 109 for supporting an electrode that is connected to the filament 102, and a structure, which is electrically connected to the filament 102 by way of the electrode to supply electric power to the filament 102 from a power supply.

Not only an inert gas but also a methane hydrocarbon gas are preferably enclosed in the bulb 101 to minimize the evaporation of the filament.

In the incandescent lamp illustrated in FIG. 1, the filament 102 has a thermally stabilized cavity structure. Thus, even when operated at a temperature of 2,000 K, the lamp can keep emitting radiations, having a spectral distribution with small infrared radiations, for a long time.

The configuration of this incandescent lamp will be described in further detail with reference to FIG. 1.

The end of the glass bulb 101 is closed with an enclosing portion 103, in which pieces 104 and 105 of metal foil (which will be referred to herein as “metal foils 104 and 105” for convenience sake) of molybdenum are enclosed airtight. One end of the metal foil 104 is connected to the stem 108 and the associated end of the metal foil 105 is connected to the stem 109. The stems 108 and 109 are partially enclosed airtight in the enclosing portion 103. The respective upper portions of the stems 108 and 109, which are located inside the glass bulb 101, are connected to the two terminals of the filament 102 and support the filament 102 thereon. The filament 102 is aligned with the center axis of the glass bulb 101. The stems 108 and 109 are preferably made of a refractory metal such as tungsten or molybdenum.

One end of an external lead 106 of molybdenum is connected to the other end of the metal foil 104 and an associated end of another external lead 107 of molybdenum is connected to that of the metal foil 105. The other ends of the external leads 106 and 107 are extended outside of the glass bulb 101.

The filament 102 is a coil of a ribbon with a width of 0.5 mm and a thickness of 0.05 mm. The coil has a length of 4.13 mm and a width of 1.44 mm.

On the outer surface of the filament 102, formed is a cavity structure that suppresses radiations having wavelengths that are longer than a predetermined value. This cavity structure is implemented as an array of cylindrical cavities 120 with a diameter of 0.4 μm, a pitch (i.e., the distance between the center axes of two adjacent cavities) of 0.8 μm and a depth of 1.0 μm. The cavities 120 are formed using a femtosecond laser.

By setting the diameter of the cavities 120 to 0.4 μm, radiations having wavelengths of 0.8 μm (i.e., a wavelength twice as long as the diameter) or more can be cut off. The depth of the cavities 120 is preferably greater than their inside diameter. The cavities 120 do not have to be formed over the entire surface of the filament 102 but may be present in at least a part of that surface.

The cavities 120 do not have to have the cylindrical shape. Alternatively, the cavities 120 may have the shape of either a quadrangular prism, one side of which is a half as long as the wavelength of radiations to be suppressed, or a groove, of which the width is a half as long as the wavelength of radiations to be suppressed. That is to say, the cavities 120 may have any arbitrary shape as long as its structure can suppress radiations, of which the wavelengths are equal to or greater than a predetermined wavelength.

If the luminous efficacy of visible radiation should be increased, the cutoff wavelength is preferably set to 780 nm. Optionally, however, by adopting a shorter cutoff wavelength, the long wavelength range of visible radiation may be partially cut off and the light emitted from the lamp may be turned bluish.

The surface of the filament 102 is coated with a layer including tungsten and carbon (i.e., a tungsten compound layer), which is formed by the carburizing process described above. This tungsten compound layer may have a thickness of about 1.8 μm. Considering possible collapse of the cavities 120, the effects of this tungsten compound layer are particularly significant if the cavities have a diameter of 5 μm or less (and if the diameter is 1 μm or less among other things).

Inside the glass bulb 101, enclosed are not only an inert gas but also a methane hydrocarbon gas. In this preferred embodiment, a gas in which 1 vol % of methane is added to argon is enclosed at a pressure of 0.1 MPa at a normal temperature. As used herein, the “normal temperature” is equivalent to room temperature of the environment in which the incandescent lamp is left.

In this preferred embodiment, 1 vol % of methane is enclosed as a methane hydrocarbon. However, the methane gas may be added at a greater volume percentage. While the incandescent lamp is operating, carbon might be consumed by being bonded to an impurity gas or oxygen that is present inside the glass bulb 101. As a result, the carbon contributing to minimizing the evaporation of tungsten carbide might run short. In view of this consideration, the gas including carbon may be added at an increased percentage to guarantee a long life.

Also, in the preferred embodiment described above, methane is used as a gas including carbon. However, the gas including carbon does not have to be methane but may also be propane or any other methane hydrocarbon. Since methane and propane are reactive to a gas which increases susceptibility of substance to burn, methane and propane are preferably added at less than 5 vol % and less than 2 vol %, respectively.

As a conventional light bulb in which a gas including carbon, as well as an inert gas, is enclosed, a halogen lamp that uses a halogenated hydrocarbon gas (of CH₃Br, for example) is known. In such a halogen lamp, a halogen is produced and corrodes the surface of a tungsten filament. This phenomenon is called a “halogen attack”, which accelerates the evaporation from the surface of the filament and eventually disconnects the filament. For example, Japanese Patent No. 2910203 mentions such a problem. Thus, a gas including carbon has sometimes been enclosed in a light bulb in the prior art, too. However, nobody has ever pointed out that a gas such as a methane hydrocarbon minimizes the evaporation of tungsten carbide.

According to the present invention, a halide may be added as a gas including carbon but the volume percentage of the halide to the overall enclosed gas should not be equal to or greater than 0.5%. That is to say, if the gas including carbon is a halide, the volume percentage of the halide to the overall enclosed gas is preferably adjusted to less than 0.5%.

Optionally, not only the gas including carbon but also other elements may be added to the enclosed gas for various purposes.

A technique of making an incandescent lamp using a radiator of tungsten carbide is disclosed in U.S. Patent Application Publication No. US2005/0263269. Hereinafter, it will be described why such a technique of using tungsten carbide as a filament material had never been reported before the priority date of the PCT international application identified above.

First of all, tungsten carbide has a higher infrared emissivity than tungsten. If the infrared emissivity is high, then the luminous efficacy of visible radiation decreases, and therefore, such a material is not adopted for a light bulb that should have as high visible radiation luminous efficacy as possible. Secondly, the melting point of tungsten carbide (of about 3,175 K) is lower than that of tungsten (of about 3,650 K) by as much as several hundreds K.

FIG. 5 is a graph showing the emissivity values of tungsten and tungsten carbide in the infrared range. In FIG. 5, the abscissa represents the wavelength and the ordinate represents the emissivity. As can be seen from FIG. 5, the emissivity of tungsten carbide (WC) in the infrared range is higher than that of tungsten (W) in the same range. For example, at a wavelength of 2.5 μm, tungsten has an emissivity of 20%, while tungsten carbide has an emissivity of 70%. As a result, visible radiation accounts for a lower percentage of the overall radiations from tungsten carbide. That is why if a filament were made of tungsten carbide, the luminous efficacy in the visible radiation range would decrease so significantly compared with a tungsten filament that the tungsten carbide filament could not be used to make a light bulb.

A history of development of incandescent lamps teaches us that light bulbs with a carbon filament having a high evaporation rate and a high infrared emissivity (which are called “Edison bulbs with a carbon filament”) were initially used for some time after the incandescent lamp was invented. After that, the carbon filament was gradually replaced with a tungsten filament having the highest melting point among various metals. Such a historical background formed a basis for a common technical misconception that tungsten carbide, having a lower melting point and a lower radiation efficiency than tungsten, should not be used as a filament for a light bulb.

On the other hand, the radiator of the present invention dares to use tungsten carbide, which has a relatively low radiation efficiency in the visible radiation range, but has a microcavity structure on its surface. That is why the radiator of the present invention can cut down infrared radiations sufficiently and can reduce the high infrared emissivity, which should be shown by tungsten carbide otherwise, to a rather low level. In addition, since the radiator of the present invention can improve the radiation efficiency, the operating temperature can also be decreased compared with a situation where a tungsten filament is used. Taking these results into account, tungsten carbide, which has never been used in the prior art, can now be used effectively as a filament for a light bulb.

Among other things, according to the present invention, not only an inert gas but also a methane hydrocarbon gas are enclosed. That is why the evaporation of the tungsten carbide layer from the surface of the filament can be minimized and the cavities on the upper surface of the filament never collapse. As a result, a light bulb that can be used for a long time is realized.

### EMBODIMENT 2

Hereinafter, a thermoelectric converter (or power generator) will be described as a preferred embodiment of an energy converter according to the present invention.

FIG. 8 schematically illustrates a configuration for a thermoelectric converter according to this preferred embodiment. The apparatus illustrated in FIG. 8 includes a radiator 40 for absorbing an external energy such as sunray (as an electromagnetic wave) and radiating an electromagnetic wave with a particular wavelength, an enclosure 46 for shutting off this radiator 40 from the air, and a converter (such as a photovoltaic cell) 44 that receives the electromagnetic wave from the radiator 40 and converts it into electrical energy. In the example shown in FIG. 8, a filter 42 for filtering out components with unnecessary wavelengths is arranged as an additional member between the radiator 40 and the converter 44. Inside the enclosure 46, enclosed are 1 vol % of methane (CH₄) and 99 vol % of Ar gas. And the overall atmosphere pressure of the enclosure 46 is equal to the atmospheric pressure.

The radiator 40 includes a body portion, which is made essentially of tungsten and of which the surface has an array of cavities to increase the radiation efficiency in the particular wavelength range. The surface regions of the radiator 40, on which the cavities are arranged, are covered with a layer including tungsten and carbon (e.g., a tungsten carbide layer) as in the first preferred embodiment described above. In this manner, the microstructure on the surface of the radiator 40 selectively radiates an electromagnetic wave with a particular wavelength, which should fall within a wavelength range in which the converter 44 can absorb the electromagnetic wave efficiently.

If the radiator 40 is supplied with energy by exposing the radiator 40 to solar heat collected, for example, then the radiator 40 that has been heated to an elevated temperature (of 2,000 K or more, for example) radiates an electromagnetic wave in a particular wavelength range. On receiving such an electromagnetic wave radiation by way of the filter 42, the converter 44 can convert the radiation into electrical energy highly efficiently.

A sunray usually includes a lot of electromagnetic waves, which fall within wavelength ranges that would result in low conversion efficiency by the converter 44. However, by using the radiator 40 of the present invention (and the filter 42), electromagnetic waves, falling within wavelength ranges that would result in high conversion efficiency, can be supplied to the converter 44. As a result, the overall conversion efficiency of an opto-thermo-electric energy conversion system can be increased. Such a thermoelectric converter can also generate electrical energy even by heating the radiator 40 with non-optical energy, and therefore, can be used in a power generator for a non-opto-thermo-electric conversion system.

A thermal electromotive force generator system that uses a radiator with such wavelength selectivity is also disclosed in Japanese Patent Application Laid-Open Publication No. 2003-332607, for example. However, this publication discloses only a radiator made of a tungsten material and does not mention at all that a microstructure would collapse or evaporate due to heat.

In the preferred embodiment of the present invention described above, the thermal stability of the cavities on the surface of the radiator 40 is increased by carbon in the layer including tungsten and carbon and in the ambient gas. Thus, the reliability of the generator system can be kept high for a long time and the radiator 40 can be operated at even higher temperatures. As a result, even a significant increase in the output of generator systems can also be coped with flexibly. Consequently, the apparatus of this preferred embodiment would contribute to protecting the global environment as a generator system that uses sunrays.

An incandescent lamp according to a preferred embodiment of the present invention includes a radiator with cavities that would not collapse for a long time even at an elevated temperature, thus providing an illumination unit with high efficiency and long life. Therefore, the lamp can be used effectively as a general illumination. The incandescent lamp can also be used effectively in shops that need high-efficiency lamps.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

What is claimed is:

1. An incandescent lamp comprising
an enclosure, and
a filament, which is arranged inside the enclosure and which includes a plurality of cavities that are arranged on at least some area of its surface,
wherein the area of the filament includes a layer including tungsten and carbon, and
wherein a gas including carbon-containing molecules is enclosed within the enclosure.

2. The incandescent lamp of claim 1, wherein the gas including carbon-containing molecules includes a hydrocarbon.

3. The incandescent lamp of claim 2, wherein the hydrocarbon is represented by the general formula CₙHₘ (where n and m are integers).

4. The incandescent lamp of claim 3, wherein m=2n+2 is satisfied.

5. The incandescent lamp of claim 4, wherein n is an integer of one through three.

6. The incandescent lamp of claim 1, wherein the layer including tungsten and carbon is a layer including tungsten carbide.

7. The incandescent lamp of claim 1, wherein the cavities have the function of suppressing radiations having wavelengths that are longer than a predetermined value.

8. The incandescent lamp of claim 1, wherein the cavities have a cylindrical shape with a diameter of 5 μm or less.

9. An energy converter comprising an enclosure, and
a radiator, which is arranged inside the enclosure and which includes a plurality of cavities that are arranged on at least some area of its surface,
wherein the area of the radiator includes a layer including tungsten and carbon, and
wherein a gas including carbon-containing molecules is enclosed within the enclosure.

10. A power generator comprising
the energy converter of claim 9, and
an element for converting radiations, produced by the energy converter, into electrical energy.
